(19) United States
(12) Patent Application Publication
(10) Pub. No.: US 2005/0040630 A1
(43) Pub. Date: Feb. 24, 2005

(54) Apparatus with specified relationship between an instrument panel and a deployment door

(75) Inventors: Kurt F. Fischer, Oxford, MI (US); Gregory S. Bayley, Dryden, MI (US)

Correspondence Address: TAROLLI, SUNDHEIM, COVELL & TUMMINO L.L.P., 526 SUPERIOR AVENUE, SUITE 1111, CLEVEVLAND, OH, 44114, US

(73) Assignee: TRW Vehicle Safety Systems Inc.

(21) Appl. No.: 10/889,951

(22) Filed: Jul. 13, 2004

Related U.S. Application Data
(63) Continuation-in-part of application No. 09/966,203, filed on Sep. 28, 2001, now Pat. No. 6,769,712.

(51) Int. Cl. B60R 21/16

(52) U.S. Cl. 280/732

(57) ABSTRACT

An apparatus (12) comprises an instrument panel (30) for a vehicle (10), an inflatable vehicle occupant protection device (60), and a deployment door (68). A portion (44) of the instrument panel (30) includes a rearwardmost point (54) of the instrument panel (30). The deployment door (68) includes a panel (72) that moves between a closed position and an open position on inflation of the protection device (60). A first end (86) of the panel (72) is connected with the portion (44) of the instrument panel (30) having the rearwardmost point (54) and is spaced from a second end (84) of the panel (72) by a first distance (E). The rearwardmost point (54) is spaced horizontally from the first end (86) of the panel (72) by a second distance (D) that is greater than the first distance (E).

### RELATED APPLICATIONS

This application is a continuation-in-part of copending patent application Ser. No. 09/966,203, filed Sep. 28, 2001.

### TECHNICAL FIELD

The present invention relates to an instrument panel and a deployment door that covers an opening in the instrument panel and opens during inflation of an inflatable vehicle occupant protection device.

### BACKGROUND OF THE INVENTION

An occupant of a vehicle may be in various positions when an air bag inflates. During inflation of the air bag, a deployment door, which covers an opening in the instrument panel through which the air bag inflates, is forced open by the inflating air bag. Typically, when the deployment door is opened by the inflating air bag, one or more panels of the deployment door swing rearwardly into a passenger compartment of the vehicle.

It is desirable for the deployment door to be designed with relation to the instrument panel so that when the deployment door is opened, the panels of the deployment door do not contact the occupant of the vehicle. If contact is unavoidable due to the position of the occupant, such contact should preferably be in a location other than under the chin of the occupant.

### SUMMARY OF THE INVENTION

The present invention relates to an apparatus comprising an instrument panel for a vehicle. A portion of the instrument panel includes a rearwardmost point of the instrument panel. The apparatus also comprises an inflatable vehicle occupant protection device. A deployment door in the instrument panel has a deployment door panel that, when in a closed position, covers at least part of a deployment opening through which the inflatable vehicle occupant protection device inflates. The deployment door panel moves to an open position on inflation of the inflatable vehicle occupant protection device. The deployment door panel has a first end and a second end. The first end of the deployment door panel is connected with the portion of the instrument panel having the rearwardmost point. The second end of the deployment door panel moves rearward and toward the portion of the instrument panel having the rearwardmost point during movement from the closed position to the open position. The first end of the deployment door panel is spaced from the second end of the panel by a first distance. The rearwardmost point of the instrument panel is spaced horizontally from the first end of the deployment door panel by a second distance that is greater than the first distance. The deployment door panel is adapted to move from the closed position to the open position without contacting an occupant, positioned in accordance with one of sections 22.4.2 and 24.4.2 of Federal Motor Vehicle Safety Standard 208, as codified in year 2003 in 49 C.F.R. 571.208, with chest on the instrument panel.

In accordance with another aspect, the present invention relates to an apparatus comprising an instrument panel for a vehicle. The instrument panel has a first portion and a second portion. The second portion of the instrument panel includes a rearwardmost point of the instrument panel. The apparatus also comprises an inflatable vehicle occupant protection device. A deployment door in the instrument panel has a closed position in which the deployment door covers a deployment opening through which the inflatable vehicle occupant protection device inflates. The deployment door includes a deployment door panel that moves to an open position on inflation of the inflatable vehicle occupant protection device. The deployment door panel has a first end and a second end. The first end of the deployment door panel is connected with the first portion of the instrument panel. The second end of the deployment door panel moves toward the first portion of the instrument panel during movement of the deployment door panel to the open position. The deployment door panel is adapted to move to the open position without contacting a chin of an occupant when the occupant is positioned in accordance with one of sections 22.4.2 and 24.4.2 of Federal Motor Vehicle Safety Standard 208, as codified in year 2003 in 49 C.F.R. 571.208, with chest on the instrument panel.

According to still another aspect, the present invention relates to an apparatus comprising an instrument panel for a vehicle. A lower portion of the instrument panel includes a rearwardmost point of the instrument panel. The apparatus also comprises an inflatable vehicle occupant protection device. A deployment door in the instrument panel has a closed position in which the deployment door covers a deployment opening through which the inflatable vehicle occupant protection device inflates. The deployment door includes an upper panel and a lower panel. A tear seam connects the upper panel to the lower panel when the deployment door is in the closed position. The tear seam ruptures and the upper and lower panels move apart from one another to move the deployment door to an open position on inflation of the inflatable vehicle occupant protection device. The tear seam is located on the deployment door so as to be located vertically above a chin of an occupant positioned with head on the instrument panel in accordance with one of sections 22.4.3 and 24.4.3 of Federal Motor Vehicle Safety Standard 208, as codified in year 2003 in 49 C.F.R. 571.208 so that the inflatable vehicle occupant protection device will not contact the occupant under the chin during inflation of the inflatable vehicle occupant protection device.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 is a schematic plan view of a vehicle including an apparatus constructed in accordance with the present invention;

FIG. 2 is a schematic elevation view of an occupant of the vehicle in a first position relative to the apparatus of FIG. 1;

FIG. 3 is a schematic elevation view of an occupant of the vehicle in a second position relative to the apparatus of FIG. 1;

FIG. 4 is a schematic enlarged view of a portion of the apparatus of FIG. 1; and

FIG. 5 is a schematic view of an alternative embodiment of an apparatus constructed in accordance with the present invention.

### DETAILED DESCRIPTION OF THE INVENTION

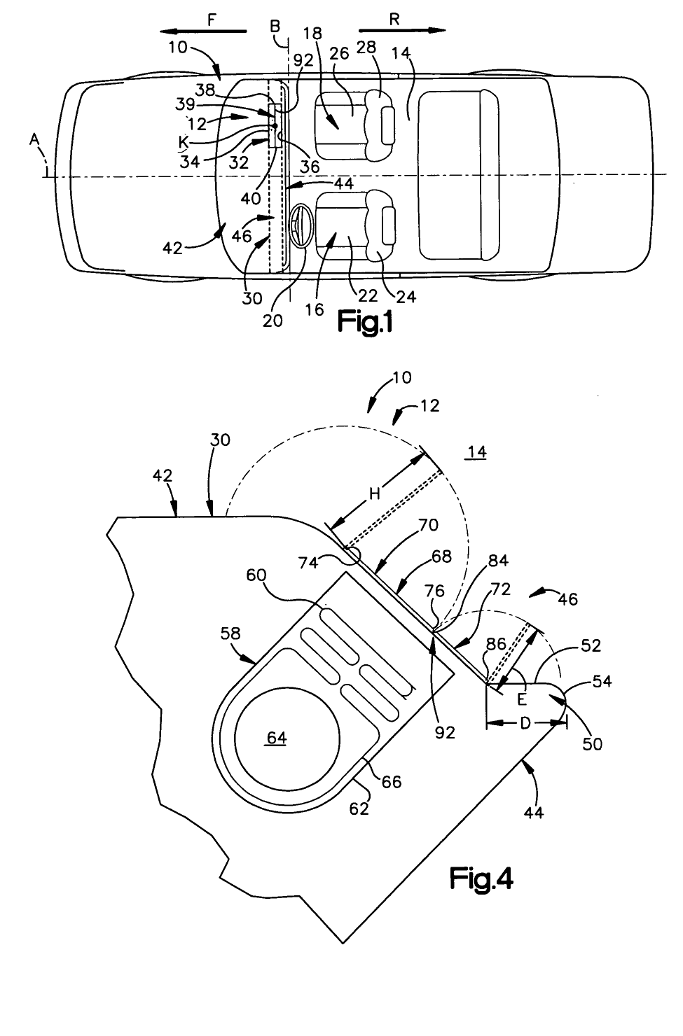

FIG. 1 illustrates, in a schematic plan view, a vehicle 10 including an apparatus 12 constructed in accordance with the present invention. An axis A extends longitudinally through the vehicle 10. A longitudinal plane of the vehicle 10 extends vertically through axis A.

A passenger compartment 14 of the vehicle 10 includes a driver seat 16 and a passenger seat 18. The driver seat 16 is situated rearward of a steering wheel 20. The arrow R in FIG. 1 indicates the rearward direction, and the arrow F indicates the forward direction. The driver seat 16 includes a seat cushion 22 and a seat back 24. The passenger seat 18 is situated adjacent the driver seat 16. The passenger seat 18 also includes a seat cushion 26 and a seat back 28.

The apparatus 12 of the vehicle 10 includes an instrument panel 30. The instrument panel 30 is located in front of both the driver seat 16 and the passenger seat 18 of the vehicle 10. The instrument panel 30 extends in a direction perpendicular to axis A along axis B. An imaginary vertical plane extending through axis B will be referred to as the widthwise plane hereinafter.

A deployment opening 32 is defined in the instrument panel 30 and is centered, along axis B, relative to the passenger seat 18. The deployment opening 32 is defined by upper and lower hinge lines 34 and 36, respectively, and vertical tear lines 38 and 40 of an H-shaped tear seam 39.

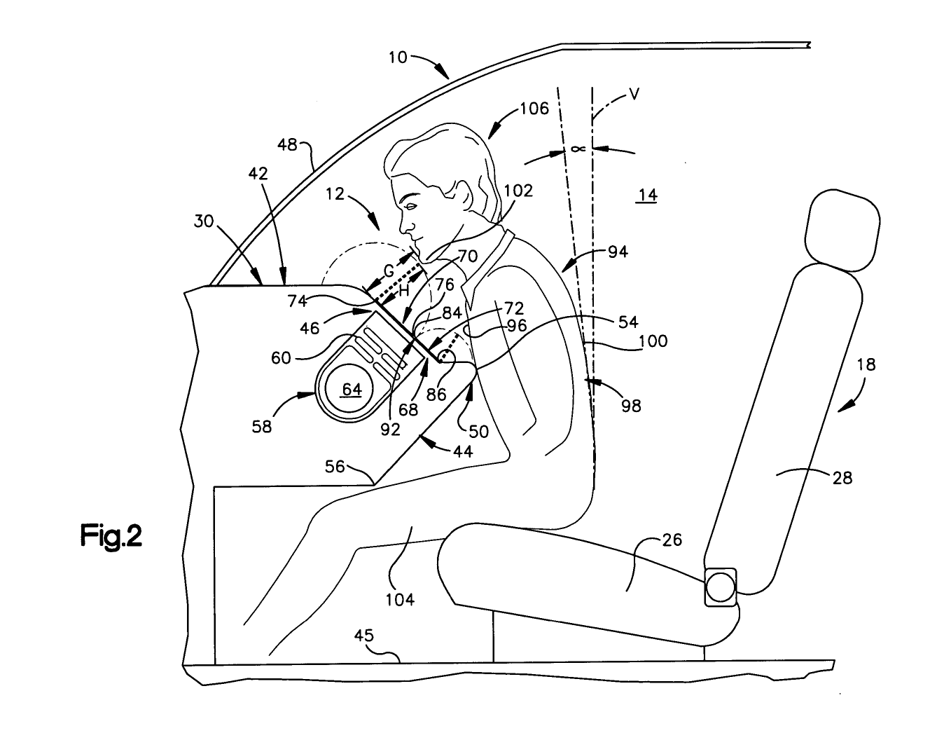

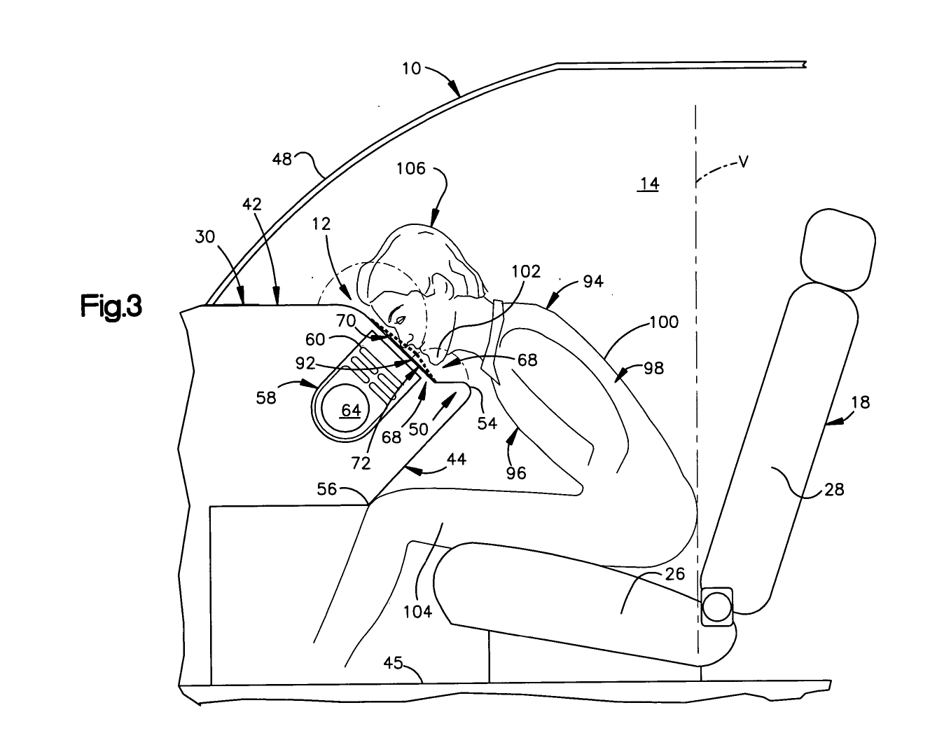

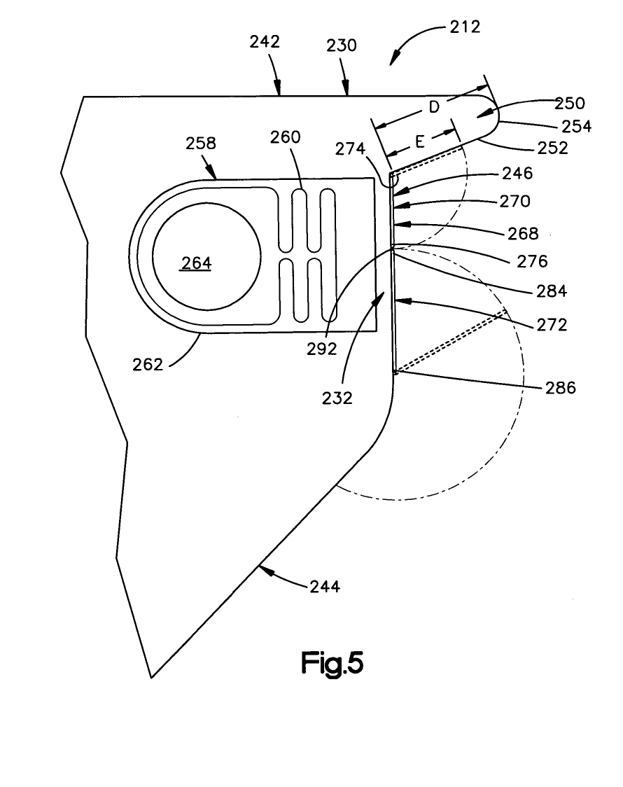

For clarity of the description, the instrument panel 30 is said to include three portions. An upper portion 42 of the instrument panel 30 extends from the upper hinge line 34 toward a windshield 48 (FIGS. 2 and 3) of the vehicle 10. A lower portion 44 of the instrument panel 30 extends from the lower hinge line 36 toward a floor 45 (FIGS. 2 and 3) of the vehicle 10. An intermediate portion 46 of the instrument panel 30 extends between the upper portion 42 and the lower portion 44 and includes both vertical tear lines 38 and 40. The intermediate portion 46 of the instrument panel is illustrated in FIG. 1 as the area between the parallel dashed lines extending from each hinge line 34 and 36. As is shown with reference to FIGS. 2 and 4, the intermediate portion 46 of the illustrated instrument panel 30 extends vertically, relative to a vertical axis V (FIG. 2) of the vehicle 10, over a distance that is approximately equal to the distance that the intermediate portion 46 extends horizontally, relative to the longitudinal axis A (FIG. 1) of the vehicle 10.

As best shown in FIG. 4, the lower portion 44 of the instrument panel 30 includes a rearward extending lip 50. The lip 50 also extends widthwise across the instrument panel 30. The rearward extending lip 50 includes an upper lip surface 52. The upper lip surface 52 extends from the lower hinge line 36 (FIG. 1) rearward and terminates at a rearwardmost point 54 of the instrument panel 30. The rearwardmost point 54 of the instrument panel 30 is located in the widthwise plane. Below the rearwardmost point 54, the lower portion 44 of the instrument panel 30 extends both downwardly and forward until terminating at a lower end 56 (FIGS. 2 and 3).

As shown in FIGS. 2-4, a module 58 including an inflatable vehicle occupant protection device 60 is attached to the instrument panel 30. The module 58 is positioned relative to the instrument panel 30 so that the inflatable vehicle occupant protection device 60, upon inflation, inflates through the deployment opening 32 (FIG. 1) and rearward into the passenger compartment 14 (FIG. 1) of the vehicle 10. The inflatable vehicle occupant protection device 60 inflates for the purpose of helping to protect an occupant of the vehicle 10 during a crash condition in which inflation of the vehicle occupant protection device 60 is desirable. The inflatable vehicle occupant protection device 60 illustrated in FIGS. 2-4 is an air bag, and the module 58 is an air bag module.

As shown in FIG. 4, the air bag module 58 includes a reaction can 62, an inflator 64, and the air bag 60. The reaction can 62 is attached to support structure (not shown) within the instrument panel 30 in a known manner. The inflator 64 is attached to the reaction can 62 in a known manner. The inflator 64 includes a source of inflation fluid. A mouth 66 of the air bag 60 is also attached to the reaction can 62. Upon actuation of the inflator 64, inflation fluid released from the inflator 64 enters the mouth 66 of the air bag 60 and causes the air bag to inflate.

A deployment door 68 is located in the deployment opening 32 in the instrument panel 30. The deployment door 68 has a closed position and an open position. In the closed position, the deployment door 68 covers the deployment opening 32 in the instrument panel 30. In the open position, the deployment door 68 enables the air bag 60 to inflate through the deployment opening 32 in the instrument panel 30 and rearward into the passenger compartment 14 of the vehicle 10. A force generated by the inflating air bag 60 causes the deployment door 68 to move from the closed position to the open position.

The deployment door 68 includes an upper panel 70 and a lower panel 72. The upper panel 70 has an upper end 74 and a lower end 76. Preferably, the upper end 74 and the lower end 76 of the upper panel 70 extend parallel to one another. The upper end 74 of the upper panel 70 is preferably connected with the upper portion 42 of the instrument panel 30 at the upper hinge line 34 (FIG. 1). An upper hinge (not shown), such as a flexible piece of plastic, may be used to connect the upper end 74 of the upper panel 70 to the upper portion 42 of the instrument panel 30. Alternatively, the deployment door 68 may be connected to the reaction can 62 in such a manner that the door can effectively pivot about the upper hinge line 34. When the deployment door 68 is in the closed position, the lower end 76 of the upper panel 70 of the deployment door 68 preferably aligns with the intermediate portion 46 (FIG. 1) of the instrument panel 30 so that the upper panel 70 of the deployment door 68 is located in the same plane as the adjacent surfaces of the instrument panel 30.

The lower panel 72 also has an upper end 84 and a lower end 86. Preferably, the upper end 84 and the lower end 86 of the lower panel 72 extend parallel to one another. The lower end 86 of the lower panel 72 is preferably connected with the lower portion 44 of the instrument panel 30 at the lower hinge line 36 (FIG. 1). A lower hinge (not shown), such as a flexible piece of plastic, may be used to connect the lower end 86 of the lower panel 72 to the lower portion 44 of the instrument panel 30. Alternatively, the deployment door 68 may be connected to the reaction can 62 in such a manner that the door can effectively pivot about the lower hinge line 36. When the deployment door 68 is in the closed position, the upper end 84 of the lower panel 72 of the deployment door 68 preferably aligns with the intermediate portion 46 (FIG. 1) of the instrument panel 30 so that the lower panel 72 of the deployment door 68 is located in the same plane as the adjacent surfaces of the instrument panel 30.

When the deployment door 68 is in a closed position, a horizontal tear line 92 (FIG. 4) of the H-shaped tear seam 39 (FIG. 1) connects the lower end 76 of the upper panel 70 with the upper end 84 of the lower panel 72. The tear seam 39 is designed to rupture when subjected to the force generated by the inflating air bag 60.

Upon the occurrence of a crash condition of a magnitude for which inflation of the air bag 60 is desired, the inflator 64 of the air bag module 58 is actuated. Upon actuation, inflation fluid is released by the inflator 64 and enters the mouth 66 of the air bag 60. The inflation fluid begins to inflate the air bag 60. As the air bag 60 begins to inflate, the inflating air bag 60 presses against the upper and lower panels 70 and 72 of the deployment door 68. As the air bag 60 continues to inflate, pressure applied by the air bag 60 against the deployment door 68 causes the tear seam 39 to rupture. When the tear seam 39 ruptures, the air bag 60 begins to inflate through the deployment opening 32 in the instrument panel 30 and rearward into the passenger compartment 14 of the vehicle 10. As the air bag 60 inflates through the deployment opening 32, the upper and lower panels 70 and 72 of the deployment door 68 are moved from the closed position to the open position.

When moving to the open position, the lower end 76 of the upper panel 70 of the deployment door 68 moves toward the upper portion 42 of the instrument panel 30. Specifically, the upper panel 70 rotates about the upper hinge line 34, or the upper hinge if used, during movement to the open position. FIGS. 2-4 illustrate an arc of movement of the lower end 76 of the upper panel 70 during movement of the upper panel 70 from the closed position to the open position.

When moving to the open position, the upper end 84 of the lower panel 72 of the deployment door 68 moves rearward and toward the lower portion 44 of the instrument panel 30. Specifically, the lower panel 72 rotates about the lower hinge line 36, or the lower hinge if used, during movement to the open position. FIGS. 2-4 illustrate an arc of movement of the upper end 84 of the lower panel 72 during movement of the lower panel 72 from the closed position to the open position.

The apparatus 12 of the present invention is designed so that when an occupant 94 of the passenger seat 18 is in a first position relative to the instrument panel 30, the deployment door 68 will open without contacting the occupant. When the occupant 94 is in a second position relative to the instrument panel 30, where contact from the deployment door 68 is unavoidable, the deployment door 68 will not contact the occupant under the chin. Both the first and the second positions are positions in which the occupant 94 is away from the seat back 28 of the passenger seat 18. The exact positions are defined in Federal Motor Vehicle Safety Standard 208 (hereinafter “FMVSS 208”), which is codified at 49 C.F.R. §571.208 (2003), was published in the Federal Register, Vol. 68, No. 223, on Nov. 19, 2003, and which is incorporated herein by reference in its entirety. FMVSS 208 refers to the first position as the “chest on instrument panel” position and describes this position in sections 22.4.2 and 24.4.2. The second position is referred to as the “head on instrument panel” position and is described in sections 22.4.3 and 24.4.3 of the FMVSS 208.

In the first position, illustrated schematically in FIG. 2, the occupant 94 is seated on the passenger seat 18 such that a midsagittal plane of the occupant 94 is aligned longitudinally, with a tolerance of ten millimeters, with point K (FIG. 1) on the instrument panel 30. Point K is located on the instrument panel 30 within six millimeters of a point that is defined by the intersection of the instrument panel and a line that connects the volumetric center of the smallest volume that can encompass the folded undeployed air bag 60 and the volumetric center of the static fully inflated air bag.

After the midsagittal plane of the occupant 94 is aligned longitudinally with point K, a location on the occupant's chest 96 is aligned with point K, with a tolerance of ten millimeters. The location on the occupant's chest 96 is located on the midsagittal plane of the occupant 94 and is 114 millimeters from the top of the skin at the neck line pursuant to §22.4.2 of the FMVSS 208 or 139 millimeters from the top of the skin at the neck line pursuant to §24.4.2 of the FMVSS 208.

The rear face 100 of the occupant's torso 98 is oriented in the range of zero degrees to six degrees forward of vertical. Section 22.4.2 of the FMVSS 208 sets a rear face 100 orientation of zero degrees and §24.4.2 of the FMVSS 208 sets a rear face orientation of six degrees forward of vertical. In FIG. 2, axis V extends vertically. FIG. 2 schematically illustrates the angle relative to axis V as angle α. As illustrated in FIG. 2, the occupant 94 is angled at approximately six degrees forward of axis V, in conformance with §24.4.2 of the FMVSS 208. Thereafter, the occupant 94 is moved forward in the vehicle 10, without changing the angle of the rear face 100 of the occupant's torso 98, until the occupant's torso or head 106 contacts the rearwardmost point 54 of the instrument panel 30.

The apparatus 12 of the present invention is designed using the following criteria with reference to the instrument panel 30 and to the occupant 94 positioned in the first position, illustrated schematically in FIG. 2.

(i) A horizontal distance D (FIG. 4), in a direction parallel to axis A (FIG. 1), separates the lower end 86 of the lower panel 72 of the deployment door 68, or the lower hinge if used, and the vertically extending widthwise plane in which the rearwardmost point 54 on the instrument panel 30 is located. A distance E (FIG. 4) separates the lower end 86 of the lower panel 72 of the deployment door 68, or the lower hinge if used, from the uppermost point on the upper end 84 of the lower panel 72 of the deployment door 68. The horizontal distance D is greater than distance E so that the lower panel 72 of the deployment door 68 will not contact the occupant 94 positioned in the first position when the deployment door 68 moves from the closed position to the open position, as shown in FIG. 2.

(ii) A distance G (FIG. 2) separates the upper end 74 of the upper panel 70 of the deployment door 68, or the upper hinge if used, and the chin 102 of the occupant 94 when the occupant 94 is positioned in the first position. A distance H (FIGS. 2 and 4) separates the upper end 74 of the upper panel 70 of the deployment door 68, or upper hinge if used, and the lowermost point on the lower end 76 of the upper panel 70 of the deployment door 68. The distance G is greater than the distance H so that the upper panel 70 of the deployment door 68 will not contact the occupant 94 positioned in the first position when the deployment door 68 moves from the closed position to the open position, as shown in FIG. 2.

In the second position of the occupant, illustrated schematically in FIG. 3, the occupant 94 is seated on the passenger seat 18 with the passenger seat 18 at a mid-height, full rearward position. The occupant 94 is seated on the passenger seat 18 such that a midsagittal plane of the occupant 94 is aligned longitudinally, with a tolerance of ten millimeters, with point K (FIG. 1) on the instrument panel 30.

Using only the control that primarily moves the passenger seat 18 in the forward and rearward directions, shown by arrows F and R, respectively, in FIG. 1, the passenger seat 18 is moved forward until any part of the occupant 94 contacts the instrument panel 30. During forward movement of the passenger seat 18, the rear face 100 of the occupant's torso 98 is maintain at an orientation relative to the vertical axis V in the range of zero degrees to six degrees. Section 22.4.3 of the FMVSS 208 sets the orientation of the rear face 100 at zero degrees and §24.4.3 of the FMVSS 208 sets the orientation of the rear face at six degrees forward of axis V.

If no part of the occupant 94 contacts the instrument panel 30 during forward movement of the passenger seat 18, the occupant 94 is slid forward until a part of the occupant contacts the instrument panel. FIG. 3 illustrates the occupant 94 contacting the lower portion 44 of the instrument panel 30. The height of the occupant 94 and the orientation of the rear face 100 of the occupant's torso 98 are maintained during any forward sliding of the occupant. If the torso 98 or head 106 of the occupant is not contacting the instrument panel 30, a force is applied to bend the occupant forward until either the torso 98 or the head 106 contact the instrument panel 30. FIG. 3 illustrates the head 106 of the occupant 94 contacting the instrument panel 30 in the second position.

The apparatus 12 of the present invention is designed using the following criterion with reference to the occupant 94 in the second position, illustrated schematically in FIG. 3.

(i) The horizontal tear line 92 of the tear seam 39 of the deployment door 68 is above the chin 102 of the occupant 94 and the rearwardmost point 54 of the lower portion 44 of the instrument panel 30 is below the chin 102 of the occupant 94. With the occupant's chin 102 interposed between the horizontal tear line 92 of the tear seam 39 and the rearwardmost point 54 of the instrument panel 30, an inflating air bag 60 will not contact the occupant 94 positioned in the second position under the chin 102 during inflation. Also, the panels 70 and 72 of the deployment door 68, when moving from the closed position to the open position, will not contact the occupant 94 under the chin 102. Thus, when the occupant 94 is positioned in the second position and contact from the deployment door 68 is unavoidable, the deployment door 68 will not contact the occupant under the chin 102.

FIG. 5 shows an alternate embodiment of an apparatus 212 constructed in accordance with the present invention. The apparatus 212 includes an instrument panel 230 having an upper portion 242 and a lower portion 244. The upper portion 242 of the instrument panel 230 includes a rearward extending lip 250. The lip 250 also extends widthwise across the instrument panel 230. The rearward extending lip 250 includes a lower lip surface 252. The lower lip surface 252 extends from an upper hinge line (not shown) rearward and terminates at a rearwardmost point 254 of the instrument panel 230. The rearwardmost point 254 of the instrument panel 230 is located in the widthwise plane. Above the rearwardmost point 254, the upper portion 242 of the instrument panel 230 extends rearward toward a windshield (not shown) of the vehicle.

A module 258 including an inflatable vehicle occupant protection device 260 is attached to the instrument panel 230. The module 258 is positioned relative to the instrument panel 230 so that the inflatable vehicle occupant protection device 260, upon inflation, inflates through a deployment opening 232 and rearward into the passenger compartment 214 of the vehicle. The inflatable vehicle occupant protection device 260 inflates for the purpose of helping to protect an occupant of the vehicle during a crash condition in which inflation of the vehicle occupant protection device 260 is desirable. The inflatable vehicle occupant protection device 260 illustrated in FIG. 5 is an air bag, and the module 258 is an air bag module. The air bag module 258 is of known construction and includes a reaction can 262, an inflator 264, and the air bag 260.

A deployment door 268 is located in the deployment opening 232 in the intermediate portion 246 of the instrument panel 230. In a manner similar to the intermediate portion 46 of FIG. 2, the intermediate portion 246 of the instrument panel 230 of FIG. 5 is defined between the upper and lower hinge lines (not shown) of the deployment door. In FIG. 5, both the deployment door 268 and the intermediate portion 246 of the instrument panel 230 extend vertically. The deployment door 268 has a closed position and an open position. In the closed position, the deployment door 268 covers the deployment opening 232 in the instrument panel 230. In the open position, the deployment door 268 enables the air bag 260 to inflate through the deployment opening 232 in the instrument panel 230 and rearward into the passenger compartment 214 of the vehicle. A force generated by the inflating air bag 260 causes the deployment door 268 to move from the closed position to the open position.

The deployment door 268 includes an upper panel 270 and a lower panel 272. The upper panel 270 has an upper end 274 and a lower end 276. The upper end 274 of the upper panel 270 connects with the lower lip surface 252 of the rearward extending lip 250 of the instrument panel 230 at the upper hinge line. An upper hinge (not shown), such as a flexible piece of plastic, may be used to connect the upper end 274 of the upper panel 270 to the lower lip surface 252. Alternatively, the deployment door 268 may be connected to the reaction can 262 in such a manner that the door can effectively pivot about the upper hinge line. When the deployment door 268 is in the closed position, the deployment door 268 is preferably located in the same plane as the adjacent surfaces of the instrument panel 230.

The lower panel 272 also has an upper end 284 and a lower end 286. Preferably, the upper end 284 and the lower end 286 of the lower panel 272 extend parallel to one another. The lower end 286 of the lower panel 272 is preferably connected with the lower portion 244 of the instrument panel 230 at a lower hinge line (not shown). A lower hinge (not shown), such as a flexible piece of plastic, may be used to connect the lower end 286 of the lower panel 272 to the lower portion 244 of the instrument panel 230. Alternatively, the deployment door 268 may be connected to the reaction can 262 in such a manner that the door can effectively pivot about the lower hinge line. When the deployment door 268 is in the closed position, the deployment door 268 is preferably located in the same plane as the adjacent surfaces of the instrument panel 330.

When the deployment door 268 is in a closed position, a horizontal tear line 292 of an H-shaped tear seam connects the lower end 276 of the upper panel 270 with the upper end 284 of the lower panel 272. The tear seam is designed to rupture when subjected to the force generated by the inflating air bag 260.

Upon the occurrence of a crash condition of a magnitude for which inflation of the air bag 260 is desired, the inflator 264 of the air bag module 258 is actuated. Upon actuation, inflation fluid is released by the inflator 264 and enters the air bag 260. The inflation fluid begins to inflate the air bag 260. As the air bag 260 begins to inflate, the inflating air bag 260 presses against the upper and lower panels 270 and 272 of the deployment door 268. As the air bag 260 continues to inflate, pressure applied by the air bag 260 against the deployment door 268 causes the tear seam to rupture. When the tear seam ruptures, the air bag 260 begins to inflate through the deployment opening 232 in the instrument panel 230 and rearward into the passenger compartment of the vehicle. As the air bag 260 inflates through the deployment opening 232, the upper and lower panels 270 and 272 of the deployment door 268 are moved from the closed position to the open position.

When moving to the open position, the lower end 276 of the upper panel 270 of the deployment door 268 moves toward the lower lip surface 252 of the lip 250 of the instrument panel 30. Specifically, the upper panel 270 rotates about the upper hinge line, or the upper hinge if used, during movement to the open position. FIG. 5 illustrates an arc of movement of the lower end 276 of the upper panel 270 during movement of the upper panel 270 from the closed position to the open position.

When moving to the open position, the upper end 284 of the lower panel 272 of the deployment door 268 moves rearward and toward the lower portion 244 of the instrument panel 230. Specifically, the lower panel 272 rotates about the lower hinge line, or the lower hinge if used, during movement to the open position. FIG. 5 illustrates an arc of movement of the upper end 284 of the lower panel 272 during movement of the lower panel 272 from the closed position to the open position.

As discussed above with reference to apparatus 12, apparatus 212 is also designed so that when an occupant of a passenger seat, such as passenger seat 18 in FIG. 1, is in the first position relative to the instrument panel 230, the deployment door 268 will open without contacting the occupant. When the occupant is in the second position relative to the instrument panel 230, where contact from the deployment door 268 is unavoidable, the deployment door 268 will not contact the occupant under the chin. Both the first and the second positions are positions in which the occupant is away from the seat back of the passenger seat. The exact positions are defined in the FMVSS 208, which is codified at 49 C.F.R. §571.208 (2003) and which is incorporated herein by reference in its entirety. FMVSS 208 refers to the first position as the “chest on instrument panel” position and describes this position in sections 22.4.2 and 24.4.2. The second position is referred to as the “head on instrument panel” position and is described in sections 22.4.3 and 24.4.3 of the FMVSS 208.

The apparatus 212 of the present invention is designed using the similar criteria as were set forth above with reference to apparatus 12. Specifically, with reference to the instrument panel 230 and to an occupant (not illustrated in FIG. 5) positioned in the first position, the criteria for apparatus 212 are as follows:

(i) A horizontal distance D separates the upper end 274 of the upper panel 270 of the deployment door 268, or the upper hinge if used, and the vertically extending widthwise plane in which the rearwardmost point 254 on the instrument panel 230 is located. A distance E separates the upper end 274 of the upper panel 270 of the deployment door 268, or the upper hinge if used, from the lowermost point on the lower end 276 of the upper panel 270 of the deployment door 268. The horizontal distance D is greater than distance E so that the upper panel 270 of the deployment door 268 will not contact the occupant positioned in the first position when the deployment door 268 moves from the closed position to the open position.

(ii) Due to the location of the rearward extending lip 250 with respect to the upper panel 270 of the deployment door 268 of apparatus 212, the upper panel 270 of the deployment door 268 will not contact the occupant positioned in the first position when the deployment door 268 moves from the closed position to the open position. Additionally, when the occupant is in the second position, the upper panel 270 of the deployment door 268 will not contact the occupant under the chin. The location of the rearward extending lip 250 with respect to the upper panel 270 of the deployment door 268 of apparatus 212 prevents contact with the occupant's chin.

From the above description of the invention, those skilled in the art will perceive improvements, changes and modifications. Such improvements, changes and modifications within the skill of the art are intended to be covered by the appended claims.

For purposes of full disclosure, sections 22.4 and 24.4 of the FMVSS 208, as codified at 49 C.F.R. §571.208 (2003), are reproduced below. These sections are reproduced as published in the Federal Register, Vol. 68, No. 223, Nov. 19, 2003.

§22.4 Low risk deployment tests.
§22.4.1 Each vehicle that is certified as complying with S21.4 shall meet the following test requirements with the 49 CFR Part 572, Subpart P 3-year-old child dummy in both of the following positions: Position 1 (S22.4.2) and Position 2 (S22.4.3).
   §22.4.1.1 Locate and mark a point on the front of the dummy's chest jacket on the midsaggital plane which is 114 mm (4.5 in) ±3 mm (±0.1 in) along the surface of the skin from the top of the skin at the neck line. This is referred to as “Point 1.”
   §22.4.1.2 Mark a point on the instrument panel that is longitudinally and transversely, as measured along the surface of the instrument panel, within ±6 mm (±0.2 in) of the point that is defined by the intersection of the instrument panel and a line between the volumetric center of the smallest volume that can encompass the folded undeployed air bag and the volumetric center of the static fully inflated air bag.
   §22.4.1.3 Locate the vertical plane parallel to the vehicle longitudinal centerline through the point located in §22.4.1.2. This is referred to as “Plane D.”
   §22.4.1.4 Locate the horizontal plane through the point located in §22.4.1.2. This is referred to as “Plane C.”
§22.4.2 Position 1 (chest on instrument panel).
   §22.4.2.1 Set the seat and seat cushion in the positions determined in §16.2.10.3.1. If the seat back is adjustable independent of the seat, place the seat back at the manufacturer's nominal design seat back angle for a 50th percentile adult male as specified in §8.1.3. Position any adjustable parts of the seat that provide additional support so that they are in the lowest or most open adjustable position. If adjustable, set the head restraint in the lowest and most forward position.
   §22.4.2.2 Place the dummy in the front outboard passenger seat such that:
      §22.4.2.2.1 The midsagittal plane is coincident with Plane D within ±10 mm (±0.4 in).
      §22.4.2.2.2 The legs are initially vertical to the floor pan. The legs and thighs shall be adjusted to the extent necessary for the head/torso to contact the instrument panel as specified in S22.4.2.3.
      §22.4.2.2.3 The upper arms are parallel to the torso and the hands are in contact with the thighs.
   §22.4.2.3 Without changing the seat position and with the dummy's thorax instrument cavity rear face vertical, move the dummy forward until the dummy head/torso contacts the instrument panel. If the dummy loses contact with the seat cushion because of the forward movement, maintain the height of the dummy and the angle of the thigh with respect to the torso. Once contact is made, raise the dummy vertically until Point 1 lies in Plane C within ±10 mm (±0.4 in). If the dummy's head contacts the windshield and keeps Point 1 from reaching Plane C, lower the dummy until there is no more than 5 mm (0.2 in) clearance between the head and the windshield. (The dummy shall remain in contact with the instrument panel while being raised or lowered, which may change the dummy's fore-aft position.)
   §22.4.2.4 If possible, position the legs of the dummy so that the legs are vertical and the feet rest flat on the floor pan of the vehicle. If the positioning against the instrument panel does not allow the feet to be on the floor pan, the feet shall be parallel to the floor pan.
   §22.4.2.5 If necessary, material with a maximum breaking strength of 311 N (70 lb) and spacer blocks may be used to support the dummy in position. The material should support the torso rather than the head. Support the dummy so that there is minimum interference with the full rotational and translational freedom for the upper torso of the dummy and the material does not interfere with the air bag.
§22.4.3 Position 2 (head on instrument panel).
   §22.4.3.1 Place the front outboard passenger seat at mid-height, in full rearward seating position determined in §22.1.7.4. Place the seat back, if adjustable independent of the seat, at the manufacturer's nominal design seat back angle for a 50th percentile adult male as specified in S8.1.3. Position any adjustable parts of the seat that provide additional support so that they are in the lowest or most open adjustment position. If adjustable, set the head restraint in the lowest and most forward position.
   S22.4.3.2 Place the dummy in the front outboard passenger seat such that:
      §22.4.3.2.1 The midsagittal plane is coincident with Plane D within ±10 mm (±0.4 in).
      §22.4.3.2.2 The legs are vertical to the floor pan, the back of the legs are in contact with the seat cushion, and the dummy's thorax instrument cavity rear face is vertical. If it is not possible to position the dummy with the legs in the prescribed position, rotate the legs forward until the dummy is resting on the seat with the feet positioned flat on the floor pan, and the back of the legs are in contact with the front of the seat cushion. Set the transverse distance between the longitudinal centerlines at the front of the dummy's knees at 86 to 91 mm (3.4 to 3.6 in), with the thighs and the legs of the dummy in vertical planes.
      §22.4.3.2.3 The upper arms are parallel to the torso and the hands are in contact with the thighs.
   §22.4.3.3 Using only the control that primarily moves the seat in the fore and aft direction, move the seat forward, while maintaining the thorax instrument cavity rear face orientation until any part of the dummy contacts the vehicle's instrument panel.
   §22.4.3.4 If dummy contact has not been made with the vehicle's instrument panel at the full forward seating position of the seat, slide the dummy forward until contact is made. Maintain the thorax instrument cavity rear face vertical orientation. If the dummy loses contact with the seat, from that point forward, maintain the height of the dummy. Except as provided in §22.4.3.5 maintain the angle of the thigh with respect to the horizontal.
   §22.4.3.5 If head/torso contact with the instrument panel has not been made, maintain the angle of the thighs with respect to the horizontal while applying a force towards the front of the vehicle on the spine of the dummy between the shoulder joints until the head or torso comes into contact with the vehicle's instrument panel or until a maximum force of 222 N (50 lb) is achieved. If the head/torso is still not in contact with the instrument panel, hold the femurs and release the 222 N (50 lb) force. While maintaining the relative angle between the torso and the femurs, roll the dummy forward on the seat cushion, without sliding, until head/torso contact with the instrument panel is achieved. If seat contact is lost prior to or during femur rotation out of the horizontal plane, constrain the dummy to rotate about the dummy H-point.
   §22.4.3.6 If necessary, material with a maximum breaking strength of 311 N (70 lb) and spacer blocks may be used to support the dummy in position. The material should support the torso rather than the head. Support the dummy so that there is minimum interference with the full rotational and translational freedom for the upper torso of the dummy and the material does not interfere with the air bag.
§22.4.4 Deploy the front outboard passenger frontal air bag system. If the frontal air bag system contains a multistage inflator, the vehicle shall be able to comply with the injury criteria at any stage or combination of stages or time delay between successive stages that could occur in a rigid barrier crash test at or below 26 km/h (16 mph), under the test procedure specified in S22.5.

§24.4 Low risk deployment tests.
§24.4.1 Each vehicle that is certified as complying with S23.4 shall meet the following test requirements with the 49 CFR Part 572 Subpart N 6-year-old child dummy in both of the following positions: Position 1 (S24.4.2) or Position 2 (S24.4.3).
   §24.4.1.1 Locate and mark a point on the front of the dummy's chest jacket on the midsagittal plane which is 139 mm (5.5 in) ±3 mm (±0.1 in) along the surface of the skin from the top of the skin at the neckline. This is referred to as “Point 1.”
   §24.4.1.2 Mark a point on the instrument panel that is longitudinally and transversely, as measured along the surface of the instrument panel, within ±6 mm (±0.2 in) of the point that is defined by the intersection of the instrument panel and a line between the volumetric center of the smallest volume that can encompass the folded undeployed air bag and the volumetric center of the static fully inflated air bag.
   §24.4.1.3 Locate the vertical plane parallel to the vehicle longitudinal centerline through the point located in §24.4.1.2. This is referred to as “Plane D.”
   §24.4.1.4 Locate the horizontal plane through the point located in §24.4.1.2. This is referred to as “Plane C.”
§24.4.2 Position 1 (chest on instrument panel).
   §24.4.2.1 Set the seat and seat cushion in the positions determined in §16.2.10.3.1. If the seat back is adjustable independent of the seat, place the seat back at the manufacturer's nominal design seat back angle for a 50th percentile adult male as specified in §8.1.3. Position any adjustable parts of the seat that provide additional support so that they are in the lowest or most open adjustable position. If adjustable, set the head restraint in the lowest and most forward position.
   §24.4.2.2 Remove the legs of the dummy at the pelvic interface.
   §24.4.2.3 Place the dummy in the front outboard passenger seat such that:
      (a) The midsagittal plane is coincident with Plane D within ±10 mm (±0.4 in).
      (b) The upper arms are parallel to the torso and the hands are next to where the thighs would be.
      (c) Without changing the seat position and with the dummy's thorax instrument cavity rear face 6 degrees forward of the vertical, move the dummy forward until the dummy head/torso contacts the instrument panel. If the dummy loses contact with the seat cushion because of the forward movement, maintain the height of the dummy while moving the dummy forward. If the head contacts the windshield before head/torso contact with the instrument panel, maintain the thorax instrument cavity angle and move the dummy forward such that the head is following the angle of the windshield until there is head/torso contact with the instrument panel. Once contact is made, raise or lower the dummy vertically until Point 1 lies in Plane C within ±10 mm (±0.4 in). If the dummy's head contacts the windshield and keeps Point 1 from reaching Plane C, lower the dummy until there is no more than 5 mm (0.2 in) clearance between the head and the windshield. (The dummy shall remain in contact with the instrument panel while being raised or lowered which may change the dummy's foreaft position.)
   §24.4.2.4 If necessary, material with a maximum breaking strength of 311 N (70 lb) and spacer blocks may be used to support the dummy in position. The material should support the torso rather than the head. Support the dummy so that there is minimum interference with the full rotational and translational freedom for the upper torso of the dummy and the material does not interfere with the air bag.
§24.4.3 Position 2 (head on instrument panel).
   §24.4.3.1 Place the front outboard passenger seat at the mid-height full rearward seating position determined in §24.1.2. Place the seat back, if adjustable independent of the seat, at the manufacturer's nominal design seat back angle for a 50th percentile adult male as specified in S8.1.3. Position any adjustable parts of the seat that provide additional support so that they are in the lowest or most open adjustment position. Position an adjustable head restraint in the lowest and most forward position.
   §24.4.3.2 Place the dummy in the front outboard passenger seat such that:
      (a) The midsagittal plane is coincident with Plane D within ±10 mm (±0.4 in).
      (b) The legs are perpendicular to the floor pan, the back of the legs are in contact with the seat cushion, and the dummy's thorax instrument cavity rear face is 6 degrees forward of vertical. If it is not possible to position the dummy with the legs in the prescribed position, rotate the legs forward until the dummy is resting on the seat with the feet positioned flat on the floor pan and the back of the legs are in contact with the front of the seat cushion. Set the transverse distance between the longitudinal centerlines at the front of the dummy's knees at 112 to 117 mm (4.4. to 4.6 in), with the thighs and the legs of the dummy in vertical planes.
      (c) The upper arms are parallel to the torso and the hands are in contact with the thighs.
   §24.4.3.3 Using only the control that primarily moves the seat in the fore and aft direction, move the seat forward, while maintaining the thorax instrument cavity rear face orientation until any part of the dummy contacts the vehicle's instrument panel.
   §24.4.3.4 If dummy contact has not been made with the vehicle's instrument panel at the full forward seating position of the seat, slide the dummy forward on the seat until contact is made. Maintain the thorax instrument cavity rear face orientation. If the dummy loses contact with the seat, from that point forward maintain the height of the dummy. Except as provided in §24.4.3.5 maintain the angle of the thigh with respect to the horizontal.
   §24.4.3.5 If head/torso contact with the instrument panel has not been made, maintain the angle of the thighs with respect to the horizontal while applying a force towards the front of the vehicle on the spine of the dummy between the shoulder joints until the head or torso comes into contact with the vehicle's instrument panel or until a maximum force of 222 N (50 lb) is achieved. If the head/torso is still not in contact with the instrument panel, hold the femurs and release the 222 N (50 lb) force. While maintaining the relative angle between the torso and the femurs, roll the dummy forward on the seat cushion, without sliding, until head/torso contact with the instrument panel is achieved. If seat contact is lost prior to or during femur rotation out of the horizontal plane, constrain the dummy to rotate about the dummy H-point.
   §24.4.3.6 If necessary, material with a maximum breaking strength of 311 N (70 lb) and spacer blocks may be used to support the dummy in position. Material should support the torso rather than the head. Support the dummy so that there is minimum interference with the full rotational and translational freedom for the upper torso of the dummy and the material does not interfere with the air bag.
§24.4.4 Deploy the front outboard passenger frontal air bag system. If the frontal air bag system contains a multistage inflator, the vehicle shall be able to comply with the injury criteria at any stage or combination of stages or time delay between successive stages that could occur in a rigid barrier crash test at speeds up to 26 km/h (16 mph) under the test procedure specified in S22.5.

1. An apparatus comprising:
an instrument panel for a vehicle, a portion of the instrument panel including a rearwardmost point of the instrument panel;
an inflatable vehicle occupant protection device; and
a deployment door in the instrument panel having a deployment door panel that, when in a closed position, covers at least part of a deployment opening through which the inflatable vehicle occupant protection device inflates, the deployment door panel moving to an open position on inflation of the inflatable vehicle occupant protection device, the deployment door panel having a first end and a second end, the first end of the deployment door panel being connected with the portion of the instrument panel having the rearwardmost point, the second end of the deployment door panel moving rearward and toward the portion of the instrument panel having the rearwardmost point during movement from the closed position to the open position, the first end of the deployment door panel being spaced from the second end of the panel by a first distance,
the rearwardmost point of the instrument panel being spaced horizontally from the first end of the deployment door panel by a second distance that is greater than the first distance,
the deployment door panel being adapted to move from the closed position to the open position without contacting an occupant, positioned in accordance with one of sections 22.4.2 and 24.4.2 of Federal Motor Vehicle Safety Standard 208, as codified in year 2003 in 49 C.F.R. 571.208, with chest on the instrument panel.

2. The apparatus as defined in claim 1 wherein the rearwardmost point of the instrument panel is located on a lower portion of the instrument panel, the deployment door panel being a lower panel of the deployment door, the first end of the deployment door panel being a lower end and the second end being an upper end.

3. The apparatus as defined in claim 2 wherein the deployment door further includes an upper panel that moves to an open position on inflation of the inflatable vehicle occupant protection device,
the upper panel having an upper end and a lower end, the upper end of the upper panel being connected with an upper portion of the instrument panel, the lower end of the upper panel moving toward the upper portion of the instrument panel during movement of the upper panel to the open position,
the upper panel of the deployment door being adapted to move toward the upper portion of the instrument panel without contacting a chin of the occupant.

4. The apparatus as defined in claim 1 wherein the rearwardmost point of the instrument panel is located on an upper portion of the instrument panel, the deployment door panel being an upper panel, the first end being an upper end and the second end being a lower end that is spaced vertically below the upper end.

5. The apparatus as defined in claim 4 wherein the deployment door further includes a lower panel that moves to an open position on inflation of the inflatable vehicle occupant protection device,
the lower panel having a lower end and an upper end that is spaced vertically above the lower end, the lower end of the lower panel being connected with a lower portion of the instrument panel, the upper end of the lower panel moving toward the lower portion of the instrument panel during movement of the lower panel to the open position,
the upper end of the lower panel of the deployment door being adapted to move toward the lower portion of the instrument panel without contacting the occupant.

6. An apparatus comprising:
an instrument panel for a vehicle having a first portion and a second portion, the second portion of the instrument panel including a rearwardmost point of the instrument panel;
an inflatable vehicle occupant protection device; and
a deployment door in the instrument panel having a closed position in which the deployment door covers a deployment opening through which the inflatable vehicle occupant protection device inflates, the deployment door including a deployment door panel that moves to an open position on inflation of the inflatable vehicle occupant protection device, the deployment door panel having a first end and a second end, the first end of the deployment door panel being connected with the first portion of the instrument panel, the second end of the deployment door panel moving toward the first portion of the instrument panel during movement of the deployment door panel to the open position,
the deployment door panel being adapted to move to the open position without contacting a chin of an occupant when the occupant is positioned in accordance with one of sections 22.4.2 and 24.4.2 of Federal Motor Vehicle Safety Standard 208, as codified in year 2003 in 49 C.F.R. 571.208, with chest on the instrument panel.

7. The apparatus as defined in claim 6 wherein the rearwardmost point is located on a lower portion of the instrument panel, the deployment door panel being an upper panel, and the first end being an upper end and the second end being a lower end.

8. The apparatus as defined in claim 7 wherein the deployment door further includes a lower panel that moves to an open position on inflation of the inflatable vehicle occupant protection device,
the lower panel having a lower end and an upper end, the lower end of the lower panel being connected with the lower portion of the instrument panel, the upper end of the lower panel moving rearward and toward the lower portion of the instrument panel during movement of the lower panel to the open position, the lower end of the lower panel being spaced from the upper end of the lower panel by a first distance,
the rearwardmost point of the instrument panel being spaced horizontally away from the lower end of the lower panel of the deployment door by a second distance that is greater than the first distance.

9. The apparatus as defined in claim 6 wherein the rearwardmost point is located on an upper portion of the instrument panel, the deployment door panel being a lower panel, and the first end being a lower end and the second end being an upper end.

10. The apparatus as defined in claim 9 wherein the deployment door further includes an upper panel that moves to an open position on inflation of the inflatable vehicle occupant protection device,
the upper panel having a lower end and an upper end, the upper end of the upper panel being connected with the upper portion of the instrument panel, the lower end of the upper panel moving rearward and toward the upper portion of the instrument panel during movement of the upper panel to the open position, the upper end of the upper panel being spaced from the lower end of the upper panel by a first distance,
the rearwardmost point of the instrument panel being spaced horizontally away from the upper end of the upper panel of the deployment door by a second distance that is greater than the first distance.

11. An apparatus comprising:
an instrument panel for a vehicle, a lower portion of the instrument panel including a rearwardmost point of the instrument panel;
an inflatable vehicle occupant protection device; and
a deployment door in the instrument panel having a closed position in which the deployment door covers a deployment opening through which the inflatable vehicle occupant protection device inflates, the deployment door including an upper panel and a lower panel, a tear seam connecting the upper panel to the lower panel when the deployment door is in the closed position, the tear seam rupturing and the upper and lower panels moving apart from one another to move the deployment door to an open position on inflation of the inflatable vehicle occupant protection device,
the tear seam being located on the deployment door so as to be located vertically above a chin of an occupant positioned with head on the instrument panel in accordance with one of sections 22.4.3 and 24.4.3 of Federal Motor Vehicle Safety Standard 208, as codified in year 2003 in 49 C.F.R. 571.208 so that the inflatable vehicle occupant protection device will not contact the occupant under the chin during inflation of the inflatable vehicle occupant protection device.

12. The apparatus as defined in claim 11 wherein the lower panel has a lower end and an upper end,
the lower end of the lower panel being connected with the lower portion of the instrument panel, the upper end of the lower panel moving rearward and toward the lower portion of the instrument panel when the deployment door moves from the closed position to an open position, the lower end of the lower panel being spaced from the upper end of the lower panel by a first distance,
the rearwardmost point of the instrument panel being spaced horizontally away from the lower end of the lower panel of the deployment door by a second distance that is greater than the first distance.
